(19) United States
(12) Patent Application Publication
(10) Pub. No.: US 2003/0066079 A1
(43) Pub. Date: Apr. 3, 2003

(54) Method and apparatus for program information search

(75) Inventor: Masao Suga, Ome-shi (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 10/233,541

(22) Filed: Sep. 4, 2002

(30) Foreign Application Priority Data
Oct. 1, 2001 (JP) 2001-305764

(51) Int. Cl. G06F 3/00; H04N 5/445; G06F 13/00; G10L 15/00; G10L 15/18

(52) U.S. Cl. 725/52; 725/53; 704/257; 725/44

(57) ABSTRACT

A digital television set can obtain electronic programming guide (EPG) services of various broadcast stations. A remote controller of the digital television set can input a natural language such as Japanese or English, which the human being reads and writes. A search engine searches for program information contained in the EPG services of the various broadcast stations, using, as a search key, the natural language input by the remote controller. As a result of a search operation, one or more program information items are arranged on a display in the order of rate of access, beginning from the highest one, or in the order of airtime.

### CROSS-REFERENCE TO RELATED APPLICATIONS

This application is based upon and claims the benefit of priority from the prior Japanese Patent Application No. 2001-305764, filed Oct. 1, 2001, the entire contents of which are incorporated herein by reference.

### BACKGROUND OF THE INVENTION

1. Field of the Invention

The present invention relates to a program information search method and apparatus for use in digital imaging apparatuses (digital television sets, digital recording apparatuses, etc.).

2. Description of the Related Art

Digital television sets are now popular which widely utilize digital techniques for recording, reproduction and/or transmission of image signals.

As compared to conventional analog television sets, such digital television sets are advantageous in that: they can (1) simultaneously transmit information items of different forms, such as still images and teletext information, etc., using multiplexing of digital transmission channels; (2) simultaneously transmit images of different channels using information compression techniques; (3) transmit an image with a changed resolution or configuration; and (4) execute interactive communications.

Users of digital television sets can enjoy electronic programming guide (EPG) services provided by various TV stations via, for example, a provider called “Platform”. As a result, the users can see, for example, the program lists of various TV stations on their TV screens.

However, in digital broadcasting, in which a number of channels can be used, each user can see the TV programs of a number of TV stations, but must search for a TV program of their taste from vast numbers of EPG services by themselves.

In light of this, there is a demand for a technique for efficiently finding out TV program information of user's taste.

### BRIEF SUMMARY OF THE INVENTION

Accordingly, it is an object of the present invention to provide a program information search method and apparatus capable of efficiently searching for program information of user's taste.

According to one aspect of the invention, there is provided a program information search method for use in a digital imaging apparatus capable of obtaining electronic programming guide (EPG) services of various broadcast stations, the method comprising inputting a natural language using an input device of the digital imaging apparatus; searching for program information contained in the EPG services of the various broadcast stations, using the input natural language as a search key; and displaying one or more program information items, acquired from the searching, on a screen of the digital imaging apparatus.

According to another aspect of the present invention, there is provided a program information search apparatus capable of obtaining electronic programming guide (EPG) services of various broadcast stations, comprising an input unit configured to input a natural language; a search unit configured to search for program information contained in the EPG services of the various broadcast stations, using, as a search key, the natural language input by the input unit; and a processing unit configured to display one or more program information items, acquired by the search unit.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram illustrating the entire configuration of a system for realizing a program information search method according to a first embodiment of the invention;

FIG. 2 is a view illustrating an input example executed to enable accessed program information items to be displayed in the order of their access rates;

FIG. 3 is a view illustrating an input example executed to enable accessed program information items to be displayed in the order of their airtimes;

FIG. 4 is a view illustrating a display example in which program information items accessed in accordance with the contents of the input shown in FIG. 2 are displayed in the order of their access rates;

FIG. 5 is a view illustrating a display example in which program information items accessed in accordance with the contents of the input shown in FIG. 3 are displayed in the order of their airtimes;

FIG. 6 is a flowchart useful in explaining the operation of a digital television set:

FIG. 7 is a flowchart useful in explaining the operation of a server; and

FIG. 8 is a block diagram illustrating the entire configuration of a system for realizing a program information search method according to a second embodiment of the invention.

### DETAILED DESCRIPTION OF THE INVENTION

Embodiments of the present invention will be described below with reference to the drawings.

In each embodiment, a digital television set is used as an example of a digital imaging apparatus (a digital television set, digital recording apparatus, etc.).

Firstly, a first embodiment will be described.

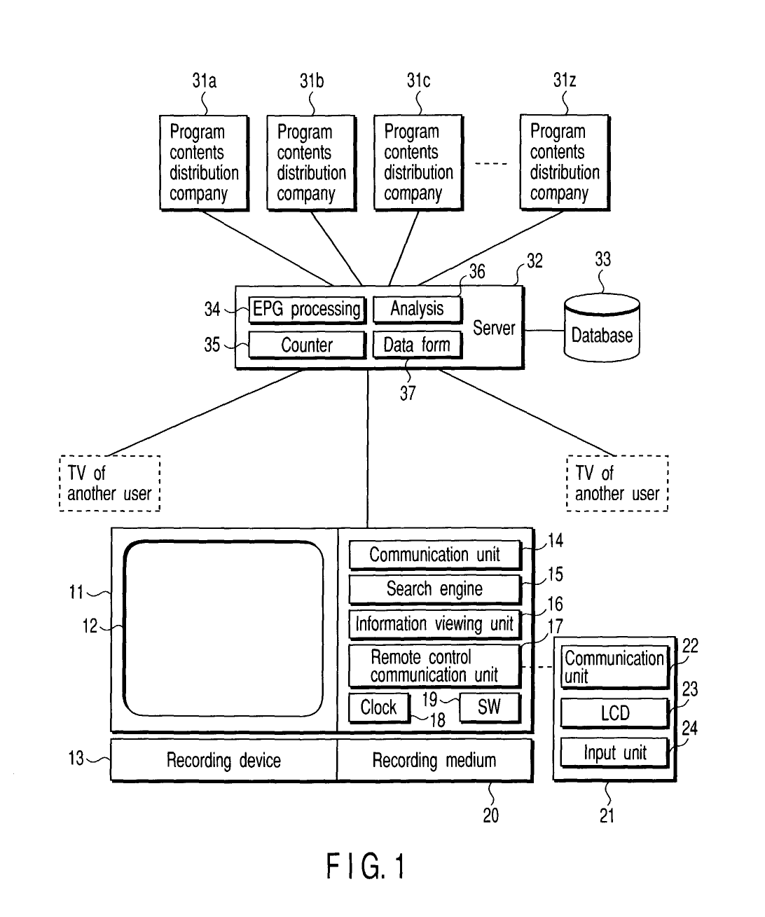

FIG. 1 is a block diagram illustrating the entire configuration of a system for realizing a program information search method according to the first embodiment of the invention.

A digital television set 11 is equipped with a receiving set for receiving television broadcasts, and therefore can obtain, via providers, electronic programming guide (EPG) services provided by various broadcast stations. The digital television set 11 includes a display 12, recording device 13, communication unit 14, search engine 15, information viewing unit (or browser) 16, remote control communication unit 17, clock 18, switch 19 and recording medium 20.

The display 12 displays various types of image information related to information viewing or search, as well as moving pictures as the programs transmitted from broadcast stations.

The recording device 13 is used to record the contents of a program transmitted from a broadcast station, and is realized by a video or DVD, etc.

The communication unit 14 accesses a server 32 to thereby transmit various data between the server 32 and digital television set 11 by radio or using a cable.

The search engine 15 is a function for searching for program information contained in the EPG services of various broadcast stations, using, as a search key, a natural language input through a remote controller 21. One or more program information items obtained by the search operation are displayed on the display 12 in the form of a list.

The information viewing unit (or browser) 16 has a function for enabling various information such as the EPG services from the server 32 to be viewed on the display 12. The search engine 15 can be used via the information viewing unit 16. The information viewing unit 16 displays, on the display 12, one or more program information items obtained by the search engine 15.

On the basis of the information obtained from the server 32 via the search engine 15, on the display 12, the information viewing unit 16 can add, to each program information item, the rate of access thereto by the users of another digital television sets, or can arrange the program information items in the order of the rates of access thereto by the users of another digital television sets, or can arrange the program information items in the order of their airtimes, or can display related information indicating, for example, what kind of program the user of the digital television set 11 likes.

The remote control communication unit 17 executes communications with a communication unit 22 incorporated in the remote controller 21.

The clock 18 measures time.

The switch 19 is used to turn on and off the digital television set 11.

The recording medium 20 is used to record personal data for the user of the digital television set 11 (e.g. a list of user's favorite programs), and is realized by, for example, a hard disk.

The digital television set 11 can records on the recording medium 20 a program information item accessed by the digital television set and an airtime corresponding to the accessed program information item, and selects a program corresponding to the accessed program information item at the airtime and displays the selected program on a screen of the digital television set at the recorded airtime, if the digital television set is in an ON state.

Further, the digital television set 11 can selects one of the one or more program information items displayed, records on the recording medium 20 the selected program information item and an airtime corresponding thereto, and selects a program corresponding to the recorded program information item and displays the selected program on a screen at the airtime.

Further, the digital television set 11 can selects one of the one or more program information items displayed, records on the recording medium 20 the selected program information item and an airtime corresponding thereto, and selects a program corresponding to the recorded program information item and records the selected program on the recording device 13 at the airtime.

The digital television set 11 incorporates the remote controller 21 for executing remote control of the television set 11. The remote controller 21 enables the user to input natural languages such as English and Japanese (Japanese syllabary characters, Katakana characters, Chinese characters, Numerals, alphabet letters, etc.), and incorporates a Japanese-syllabary-character/Chinese-character conversion function. This function may be installed in the digital television set 11. The remote controller 21 has a communication unit 22, LCD 23 and input unit 24.

The communication unit 22 executes communications with the remote control communication unit 17 of the digital television set 11.

The LCD 23 displays various data items including a natural language input. Further, it can also display a search result acquired in the digital television set 11.

The input unit 24 is formed of a plurality of input keys arranged like the ten-key arrangement or key arrangement employed in, for example, a portable telephone.

On the other hand, the server 32 is a piece of equipment of a provider “Platform”. The server receives program contents distributed from a plurality of program contents distribution companies 31a to 31z, and executes, using a database 33, integration/management of information related to the EPG services of various broadcast stations, and provides the information related to the PEG services to each digital television set.

The database 33 manages information related to the EPG services of various broadcast stations, information related to the user of each digital television set (i.e., clients), etc.

The server 32 includes an EPG processing unit 34, counter 35, analysis unit 36 and data forming unit 37, etc.

The EPG processing unit 34 forms EPG data corresponding to each broadcast station on the basis of the program contents distributed from the program contents distribution companies 31a to 31z, and stores it in the database 33.

The counter 35 counts the number of occasions of access to each program information item by the user of each digital television set.

The analysis unit 36 computes the rate of access to each program information item or the viewing rate of each program already viewed on the basis of the count results of the counter 35, or analyzes what kind of program the user of each digital television set likes on the basis of the computation results.

The data forming unit 37 forms data related to the information that is to be transmitted to each digital television set.

Upon receiving a natural language in the form of text data from each digital television set via its search engine, the server 32 searches the program information contained in the EPG services of various broadcast stations stored in the database 33, on the basis of the received text data. The server 32 then transmits, to each digital television set as a requester, one or more program information items acquired from the search operation.

Further, when transmitting program information to a digital television set as a requester, the server 32 can control the digital television set so as to add, to the program information to be displayed thereon, the rate of access to each program information item by the users of another digital television sets. The server 32 can also control the digital television set so as to arrange the program information items in the order of the rates of access thereto by the users of another digital television sets, beginning from the highest rate. The server 32 can further control the digital television set so as to arrange the program information items in the order of their airtimes.

Moreover, when a plurality of program information items whose airtimes overlap each other have been acquired from the search operation, the server 32 can control the digital television set as the requester so as to display a program information item having a higher rate of access in preference to a program information item having a lower rate of access.

In addition, the server 32 can estimate what kinds of programs the users of another digital television sets like, on the basis of the program information another digital television sets have already displayed or accessed, thereby controlling the digital television set as the requester so as to display information related thereto.

The program contents distribution companies 31a to 31z arrange program contents corresponding to each of the broadcast stations, and distribute them to a provider, such as “Platform”, which has the server 32.

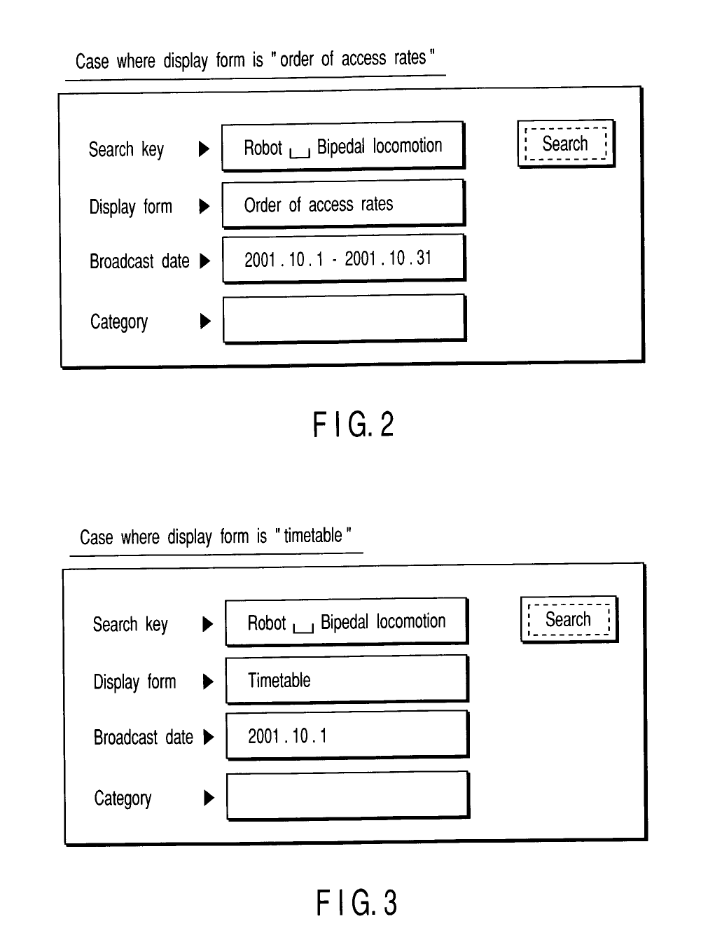

FIG. 2 is a view illustrating an input example executed to enable accessed program information items to be displayed “in the order of their access rates”.

When the search engine 15 of the digital television set 11 has been activated, a screen for executing a search operation is displayed on the display 12 (or on the LCD 23 of the remote controller 21). In this state, the user operates the input unit 24 of the remote controller 21 to fill in various input columns on the display 12.

For example, as shown in FIG. 2, “Robot Bipedal-locomotion”, “Access Rate” and “2001.10.1-2001.10.31” are input in the input columns “Search Key”, “Display Form” and “Broadcast Date”, respectively. Although data may be input in the input column “Category”, no designation is made in this case. After this input operation, the “Search” button is operated.

In particular, in the input column “Search Key”, a natural language such as English or Japanese (Japanese syllabary characters, Katakana characters, Chinese characters, Numerals, etc.) can be input. In this input column, a program name, cast, category, part of the contents of a program, etc. may be input as well as the above-mentioned words “Robot” and “Bipedal-locomotion”. Further, one or more words can be designated as shown in FIG. 2. Also, fragmentary characters, which are included in a word, can be designated. As a result, the user can easily find out desired program information.

FIG. 3 is a view illustrating an input example executed to enable accessed program information items to be displayed in the order of their airtimes.

In this case, for example, “Robot Bipedal-locomotion”, “Time-table” and “2001.10.1” are input in the input columns “Search Key”, “Display Form” and “Broadcast Date”, respectively. Although data may be input in the input column “Category”, no designation is made in this case. After this input operation, the “Search” button is operated.

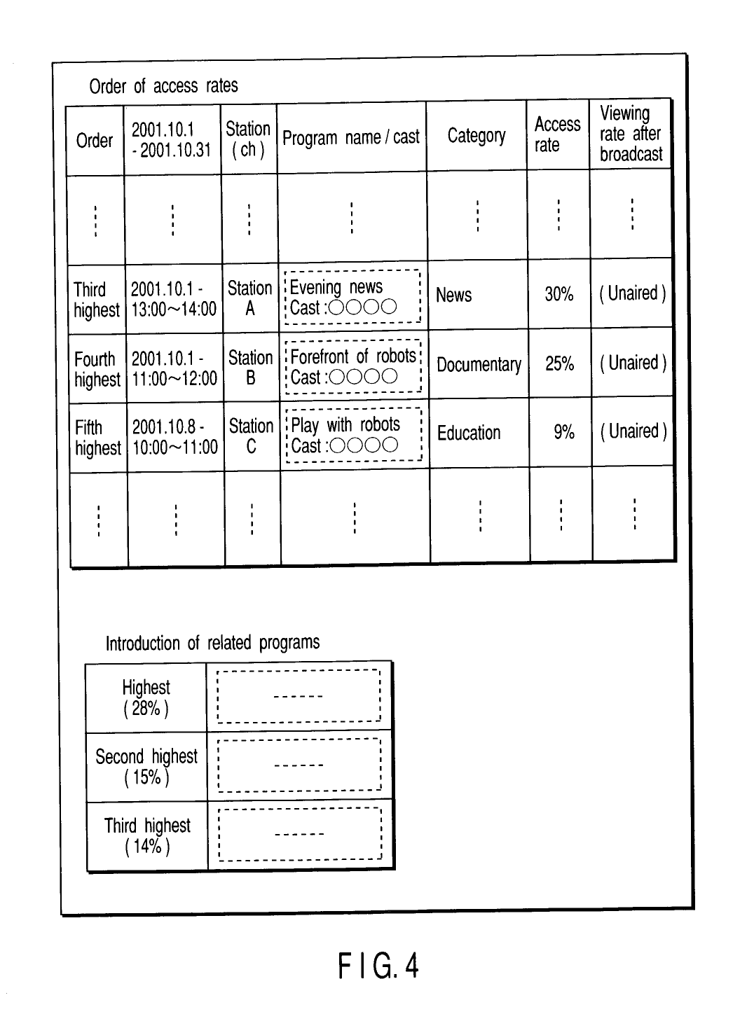

FIG. 4 is a view illustrating a display example in which program information items accessed in accordance with the contents of the input shown in FIG. 2 are displayed in the order of their access rates.

In this case, the program information items that contain both the words “Robot” and “Bipedal-locomotion” are displayed in the order of their access rates, beginning from the highest access rate. Further, in each program information item, the terms “Ranking”, “Airtime”, “Broadcast Station”, “Program/Cast”, “Order of Access Rate” and “Viewing Rate after Broadcast” are displayed. If the term “Program/Cast” is operated, the specific contents of each program are introduced.

Further, programs related to the searched program are introduced as related programs in the section “Introduction of Related Program” in the order of access rate, beginning from the highest one. The related programs are results of an analysis in which what kind of program the user of the digital TV set 11 is likely to enjoy is estimated from the programs viewed or accessed by the users of another digital TV sets. Also in the section “Introduction of Related Programs”, the specific contents of each program are introduced when it is selected.

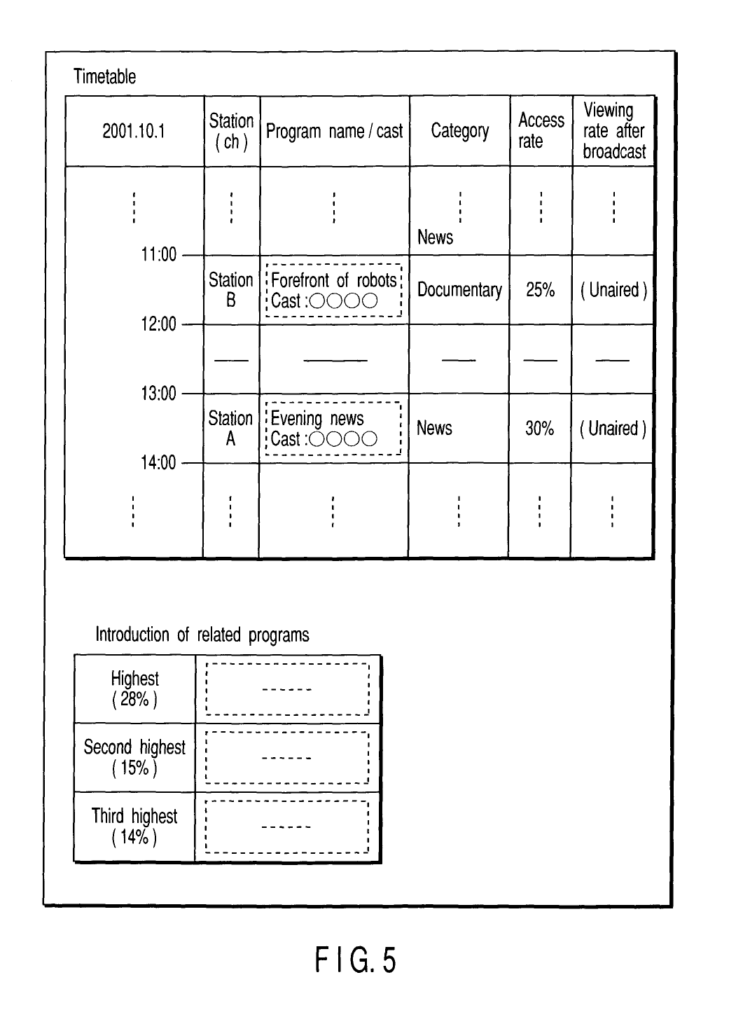

FIG. 5 is a view illustrating a display example in which program information items accessed in accordance with the contents of the input shown in FIG. 3 are displayed in the form of a timetable.

In this case, the program information items that contain both the words “Robot”and “Bipedal-locomotion” are displayed in the order of their airtimes, beginning from the earliest one. Further, in each program information item, the terms “Airtime”, “Broadcast Station”, “Program/Cast”, “Category”, “Access Rate” and “Viewing Rate after Broadcast” are displayed. Also in this case, if the term “Program/Cast” is operated, the specific contents of each program are introduced.

Further, programs related to the searched program are introduced as related programs in the section “Introduction of Related Programs” in the order of access rates, beginning from the highest one.

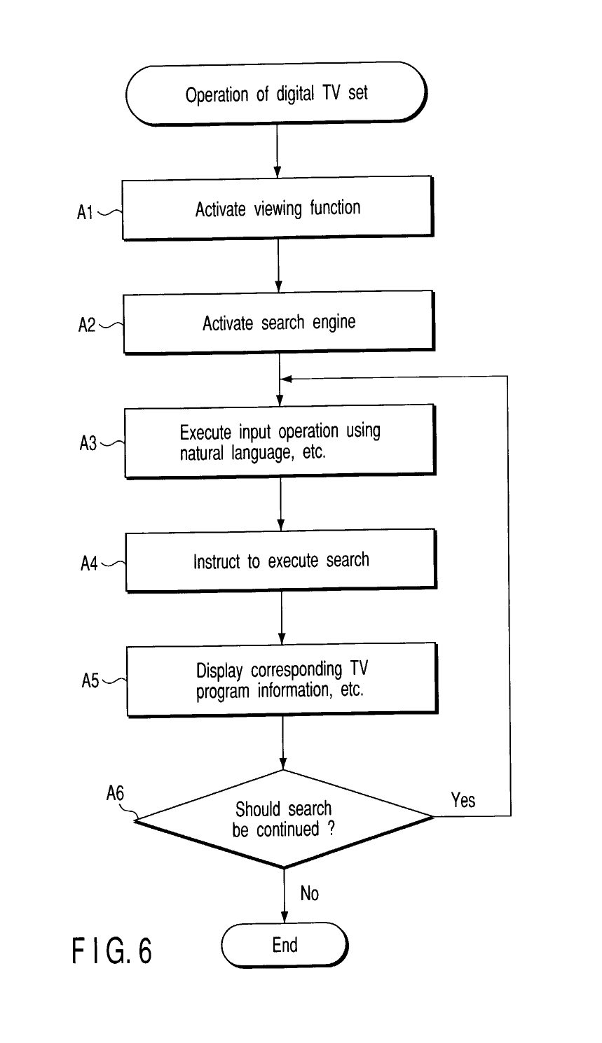

Referring now to the flowchart of FIG. 6, the operation of the digital television set 11 will be described.

On the screen of the display 12, if the information viewing unit 16 as a function for viewing various information items from the server 32 is activated (step A1), the search engine 15 has come to be usable on the screen (step A2).

To obtain desired program information, the user of the digital television set 11 inputs a natural language in the input column “Search Key” on the display 12 (step A3). At the same time, the input columns “Display Form”, “Broadcast Date”, “Category”, etc., which are columns for inputting therein conditions necessary for searching, are filled when necessary. After the necessary input operations have been executed, the user operates the search button to execute searching (step A4).

As a result, as shown in FIG. 4 or 5, a single program information item or a list of program information items are displayed on the display 12 in the designated display form, and related programs are also displayed thereon (step A5).

On the screen displayed at the step A5 (see FIG. 4 or 5), if any voluntarily-selected term “Program/Cast” is operated, the specific contents of a corresponding program are displayed. Also in the section “Introduction of Related Programs”, if any voluntarily-selected program is operated, its contents are displayed.

The user can set the above-described digital television set 11 such that, if the user selects program information they want to see, from the program information displayed, and records the selected program information and its airtime on the recording medium 20 in the form of a personal table, a TV program corresponding to the program information is automatically selected and can be seen at the set airtime when the digital television set 11 is in the ON state.

The user can also set the above-described digital television set 11 such that, if they select program information they want to see, from the program information displayed, and record the selected program information and its airtime on the recording medium 20, a TV program corresponding to the program information is automatically selected and can be seen at the set airtime when the digital television set 11 is in the ON state.

If a further search operation is executed (i.e., if the answer at a step A6 is Yes), the processes at the step A3 et seq. are repeated, whereas if no further search operation is executed (i.e., if the answer at the step A6 is No), the process is terminated.

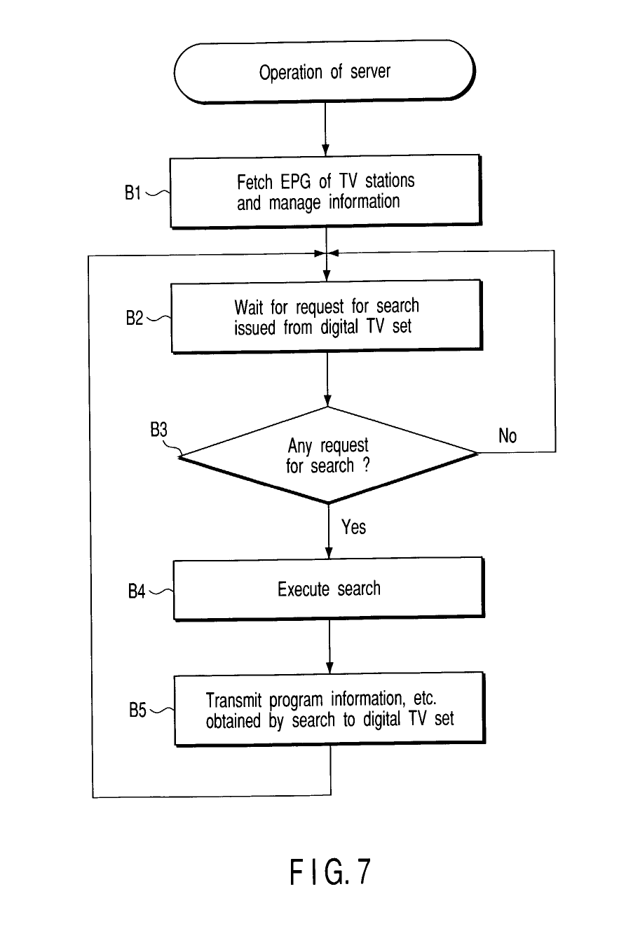

Referring to the flowchart of FIG. 7, the operation of the server 32 will be described.

The server 32 periodically fetches the EPG services of broadcast stations provided by the program contents distribution companies 31a to 31z, and manages the information contained in the database 33 so that it can always provide any information requested by its clients, i.e. the users of digital television sets (step B1). The database 33 stores information related to the user of each digital television set (clients), as well as information related to the EPG services of broadcast stations.

The server 32 is on standby until a digital television set requests for a search (step B2, and if the answer at a step B3 is No). If there is a request for search (i.e., if the answer at the step B3 is Yes), the server 32 executes an information search operation (for example, search for program information) corresponding to the request on the database 33 (step B4).

After that, the server 32 transmits the resultant program information to a digital television set as a requester (step B5).

As described above, in the first embodiment, the user of the digital television set 11 can search for desired program information using a natural language, which is very convenient. Further, the user can obtain desired information from the program contents of a plurality of broadcast stations simply by accessing the common server using their digital television set.

A second embodiment of the invention will now be described.

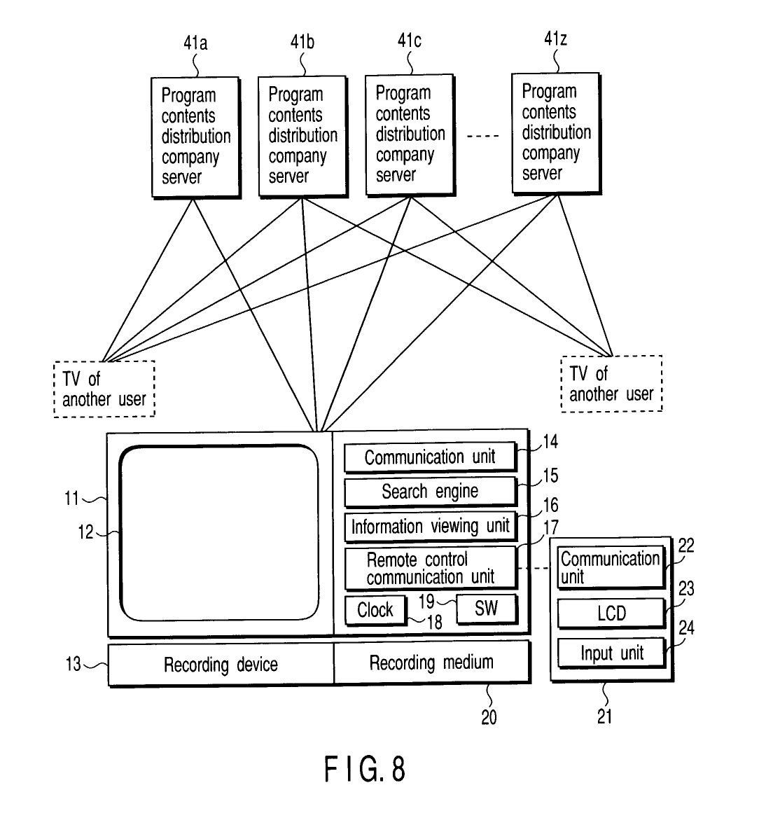

FIG. 8 is a block diagram illustrating the entire configuration of a system for realizing a program information search method according to the second embodiment of the invention. In FIG. 8, elements similar to those in FIG. 1 are denoted by corresponding reference numerals, and are not described in detail. Only different elements will be described.

The second embodiment differs from the first embodiment in that in the former, there is no common server for digital television sets.

When the digital television sets including the digital television set 11 searches for necessary program information, they individually access program contents distribution company servers 41a-41z.

The servers 41a-41z are incorporated in the program contents distribution companies 31a to 31z shown in FIG. 1, respectively. These servers each have the same functions as the server 32 shown in FIG. 1.

Accordingly, the program contents distribution company servers 41a-41z can provide program information requested by each digital television set.

Since the operations of each digital television set and server 41a-41z are similar to those shown in FIGS. 6 and 7, respectively, no detailed description is given thereof.

Thus, even the second embodiment with no common server can realize an environment in which the user of each digital television set can easily execute a search operation.

As described above in detail, the invention provides a program information search apparatus capable of efficiently finding out TV program information suitable for the tastes of users, and a program information search method for use in the apparatus.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A program information search method for use in a digital imaging apparatus capable of obtaining electronic programming guide (EPG) services of various broadcast stations, the method comprising:
inputting a natural language using an input device of the digital imaging apparatus;
searching for program information contained in the EPG services of the various broadcast stations, using the input natural language as a search key; and
displaying one or more program information items, acquired from the searching, on a screen of the digital imaging apparatus.

2. The method according to claim 1, wherein the displaying includes adding, to each program information item, a rate of access to each program information item by another digital imaging apparatuses.

3. The method according to claim 2, wherein the displaying includes arranging the program information items in an order of rate of access to each program information item by the another digital imaging apparatuses, beginning from a highest rate of access.

4. The method according to claim 1, wherein the displaying includes arranging the program information items in an order of airtime.

5. The method according to claim 4, wherein the displaying includes displaying a program information item having a higher rate of access in preference to a program information item having a lower rate of access if two or more of the program information items overlap in airtime.

6. The method according to claim 1, further comprising estimating what kind of program a user of the digital imaging apparatus likes, from an analysis based on program information the another digital imaging apparatuses have already displayed or accessed, thereby displaying an analysis result.

7. The method according to claim 1, further comprising:
recording on a recording medium a program information item accessed by the digital imaging apparatus and an airtime corresponding to the accessed program information item; and
selecting a program corresponding to the accessed program information item at the airtime and displaying the selected program on a screen of the digital imaging apparatus at the recorded airtime, if the digital imaging apparatus is in an ON state.

8. The method according to claim 1, further comprising:
selecting one of the one or more program information items displayed;
recording on a recording medium the selected program information item and an airtime corresponding thereto; and
selecting a program corresponding to the recorded program information item and displaying the selected program on a screen at the airtime.

9. The method according to claim 1, further comprising:
selecting one of one or more program information items displayed;
recording on a recording medium the selected program information item and an airtime corresponding thereto; and
selecting a program corresponding to the selected program information item and recording the selected program on a recording medium at the airtime.

10. A program information search apparatus capable of obtaining electronic programming guide (EPG) services of various broadcast stations, comprising:
an input unit configured to input a natural language;
a search unit configured to search for program information contained in the EPG services of the various broadcast stations, using, as a search key, the natural language input by the input unit; and
a processing unit configured to display one or more program information items, acquired by the search unit.

11. The apparatus according to claim 10, wherein the processing unit adds, to each program information item to be displayed, a rate of access to each program information item by another digital imaging apparatuses.

12. The apparatus according to claim 11, wherein the processing unit arranges the program information items in an order of rate of access to each program information item by the another digital imaging apparatuses, beginning from a highest rate of access.

13. The apparatus according to claim 10, wherein the processing unit arranges the program information items to be displayed in an order of airtime.

14. The apparatus according to claim 13, wherein the processing unit displays a program information item having a higher rate of access in preference to a program information item having a lower rate of access if two or more of the program information items overlap in airtime.
